(19) United States
(12) Patent Application Publication
(10) Pub. No.: US 2006/0168934 A1
(43) Pub. Date: Aug. 3, 2006

(54) Leaf removal method

(76) Inventor: Paul S. Langenfeld, St. Paul, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 11/048,238

(22) Filed: Feb. 1, 2005

(51) Int. Cl. A01D 7/00

(52) U.S. Cl. 56/400.01

(57) ABSTRACT

A method of removing leaves from a ground surface onto which they have fallen. The method employs the application of an adhesive solution to leaves over the area on which they have fallen. The solution is provided with a degree of tackiness high enough to enable the leaves to adhere to one another when the solution is allowed to dry. A blanket of the leaves thereby formed, however, is easily able to be withdrawn from the surface.

### TECHNICAL FIELD

The present invention deals broadly with the field of cleaning up of an area having a multiplicity of leaves dispersed thereon. The method employs an adhesive which enables the leaves to adhere to one another to define a blanket. Upon drying, the blanket formed will not adhere to the ground surface over which the leaves are distributed, and the blanket can, thereby, be easily removed for disposal.

### BACKGROUND OF THE INVENTION

Extensive areas of the world experience an annular cycle of climatic change. The flora of those regions does experience death and rebirth on a regular cycle. Various types of trees undergo color changes in the autumn because of chlorophyl variations as temperature and angle of incidence of the sun vary from the summer. While all the changing colors offer beauty, there is a negative side. As autumn progresses, leaves fall from the trees to the ground.

If left on the ground, leaves biologically degrade and eventually deteriorate to form a substance able to be used as a mulch. While this mulch may foster growth come spring, it tends to be very messy and unsightly. While homeowners appreciate the beauty of the changing colors, the negative effects of dying and falling leaves becomes quite inconvenient. Consequently, homeowners are constantly seeking efficient and inexpensive ways of eliminating the falling leaves from their lawns.

Typically, leaf removal will involve raking or blowing the leaves into a common pile. The piles are then filled into plastic bags for subsequent pick-up and disposal.

The typical way in which leaves are disposed of as described above can prove to be time-consuming and tiring. In the extreme, muscles can be pulled in the lifting process and, in a worst-case scenario, serious permanent back damage can be incurred.

Various tools have been developed to foster more facile leaf removal. A pick-up broom rake having a spring-loaded swinging rake head which cooperates with a fixed rake head for capturing leaves is one such tool. A tool of this nature is illustrated in U.S. Pat. No. 2,504,943 (Zifferer) Other tools are illustrated in U.S. Pat. Nos. 2,908,131 (Ross); 3,688,484 (Cox); and 4,037,397 (Fiorentino). The Ross patent teaches two rakes which are mounted pivotally relative to one another so as to enable capture of leaves from a pile. Cox teaches a tool having two pivotally connected rakes. The rake heads of the Cox reference are in opposition to one another and can engage to capture leaves. The Fiorentino reference also teaches a rake having a second pivotally-mounted rake head. Again, pivoting of two elements toward one another enables capturing of leaves.

Even when employing one or more of these tools, significant problems can be encountered. It is very common for leaves to be gathered into piles and then have the wind come along and redisperse the leaves. This, of course, causes intense frustration for the person seeking to gather, bag and dispose of the leaves in his or her yard.

It is to these dictates and shortcomings of the prior art that the present invention is directed. It is a method which allows for capturing leaves even without having to gather the leaves into piles. Much of the effort and possibility of injury is, therefore, obviated when employing the present method.

### SUMMARY OF THE INVENTION

The present invention is a method for removing leaves having fallen onto a ground area surface such as the lawn of a residential dwelling. The method includes providing an adhesive and spreading the adhesive over the ground surface and the leaves thereon. In one embodiment of the method invention, granular adhesive material is broadcast over the surface. When a granular adhesive is utilized, after it has been broadcast, a reagent, typically liquid in form, is applied. Typically, the reagent would be water, although this will not always be the case. The application of the reagent enables the granular material to form a solution which, it is intended, will leach through the layers of overlapping leaves. The solution is intended to maintain a level of tackiness sufficiently high wherein the leaves will adhere to one another. A blanket is thereby formed.

The blanket is then allowed to dry. In such a state, the blanket will not adhere to the ground surface on which it is disposed. Consequently, the blanket can be easily compacted for subsequent removal and disposal. For example, the blanket can be rolled up and easily carted off. Certainly, other forms of compaction are envisioned.

In another embodiment of practicing the method invention, the adhesive is already in a liquid solution form prior to application. Again, when in solution, the adhesive would have a degree of tackiness sufficiently high so that when the solution is applied over a designated area, the leaves will adhere to one another. At the same time, again, a blanket formed will be able to be easily withdrawn from the surface.

The present invention employs an adhesive solution which, upon drying, becomes a flexible film. It has been found that synthetic latex adhesive solutions perform particularly well for the intended purpose, if they are diluted with water so as to afford the appropriate measure of tackiness.

It will be understood that, in addition to affording appropriate tackiness, dilution will also enable a solution to be applied by a conventional spraying instrument. Various types of such instruments are available. In some cases, they are intended to be used with a liquid which basically stays in a liquid state until it is applied and allowed to dry. Other instruments, however, are intended to disperse the liquid contents of a reservoir in a manner so that it becomes atomized upon leaving a nozzle of the instrument and disperses in a fine mist.

Recognizing that, while certain trees such as oaks and maples shed leaves which will most likely cover an entire lawn but that others disperse their leaves more sparsely, the invention envisions an embodiment for use in a situation where the leaves are sparse enough so that they are non-overlapping. In such a case, the invention envisions performance of a method in which the adhesive is first applied to the surface with the leaves thereon as in the case previously described. In performing this embodiment, however, a tube, typically made of cardboard, is rolled across the leaf-dispersed surface while the adhesive is still wet and tacky. A snowballing effect will, thereby, be accomplished. Depending upon the size of the lawn, it is anticipated that a person could service the total lawn with a cardboard tube having an axial dimension of approximately three feet. It is anticipated that both the adhesive and the cardboard tube would be biodegradable. Consequently, implementation of the present invention is ecologically safe.

The present invention is thus a method for conveniently, easily and efficiently removing leaves from a lawn-type surface. More specific features and advantages obtained in view of those features will become apparent with referenced to the DETAILED DESCRIPTION OF THE INVENTION, appended claims and accompanying drawing figures.

### BRIEF DESCRIPTION OF THE DRAWINGS

FIG. 1 is a view showing an individual applying an adhesive by spraying it in a liquid form to cover leaves on the ground;

FIG. 2 illustrates a common household rake being utilized to roll a carpet, formed by the drawing of the adhesive applied to the leaves;

FIG. 3 is a view, similar to FIG. 2, illustrating another method of rolling the carpet formed by the leaves;

FIG. 4 illustrates use of a rolling tube to collect non-overlapping leaves;

FIG. 5 is an enlarged cross-sectional view illustrating overlapping leaves and adhesive leached through and between the leaves to form a film;

FIG. 6 is an enlarged perspective view illustrating a nozzle dispensing a liquid adhesive; and

FIG. 7 is a view, similar to FIG. 6, showing the nozzle distributing adhesive in an atomized mist form.

### DETAILED DESCRIPTION OF THE INVENTION

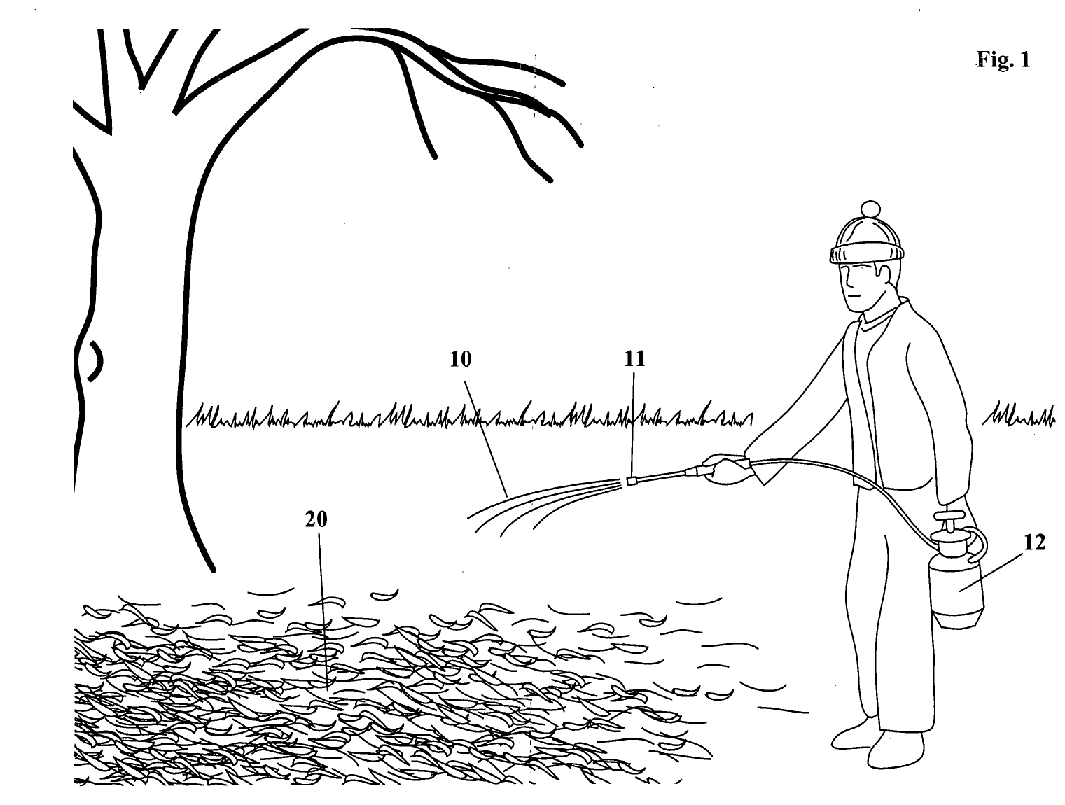

Referring now to the drawing figures wherein like reference numerals denote like elements throughout the several views, FIG. 1 illustrates an individual implementing the method in accordance with the present invention. The individual is shown as carrying a canister 12 having an adhesive solution therewithin. The canister would, typically, be pressurized so as to channel adhesive solution 10 through a hose extending from the canister 12 to a nozzle 11 at a distal end of the hose. FIG. 1 illustrates a tree devoid of leaves. The leaves 20 are lying on a ground surface around the tree. The individual is spraying the adhesive solution from the canister onto the leaves 20.

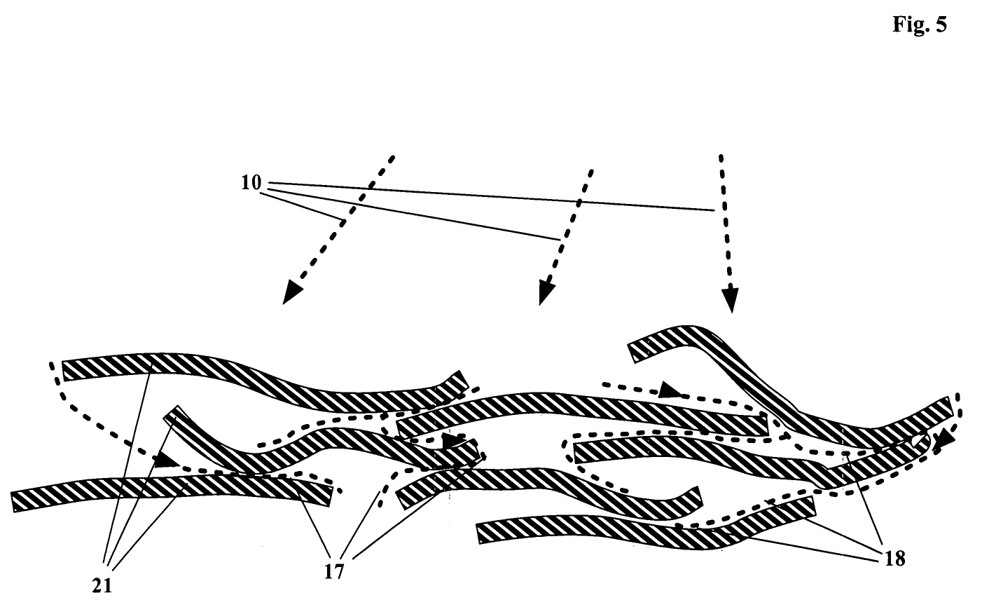

It will be understood that the intent of applying the adhesive solution is to cause the leaves 20 to become unified into a unitary blanket. This occurs in a manner as will be discussed herein with reference to FIG. 5.

After application of the solution 10, the adhesive dries and forms a flexible film. The film, when dry, has the leaves embedded therein, the adhesive 10 having leached through and around the leaves 20 to form a blanket.

It will be understood that an appropriate adhesive would be chosen for the purpose of the invention. An appropriate adhesive would have a characteristic wherein, when it were sprayed from canister 12, it would have a level of tackiness sufficiently high so that the leaves 20 would adhere to one another, but the blanket formed upon drying would be less tacky so that the blanket would not adhere to the ground surface. An appropriate adhesive to be used to perform the present method invention is marketed under the commercial name PD2121 and is manufactured by the H.B. Fuller Company.

The solution can, of course, be diluted to achieve the desired level of tackiness. By accomplishing dilution, the level of tackiness can be lowered below a level which the adhesive would normally have. Dilution also has an advantageous effect upon flow through the nozzle. The more diluted the adhesive is, the more freely flowing through the nozzle the adhesive would be.

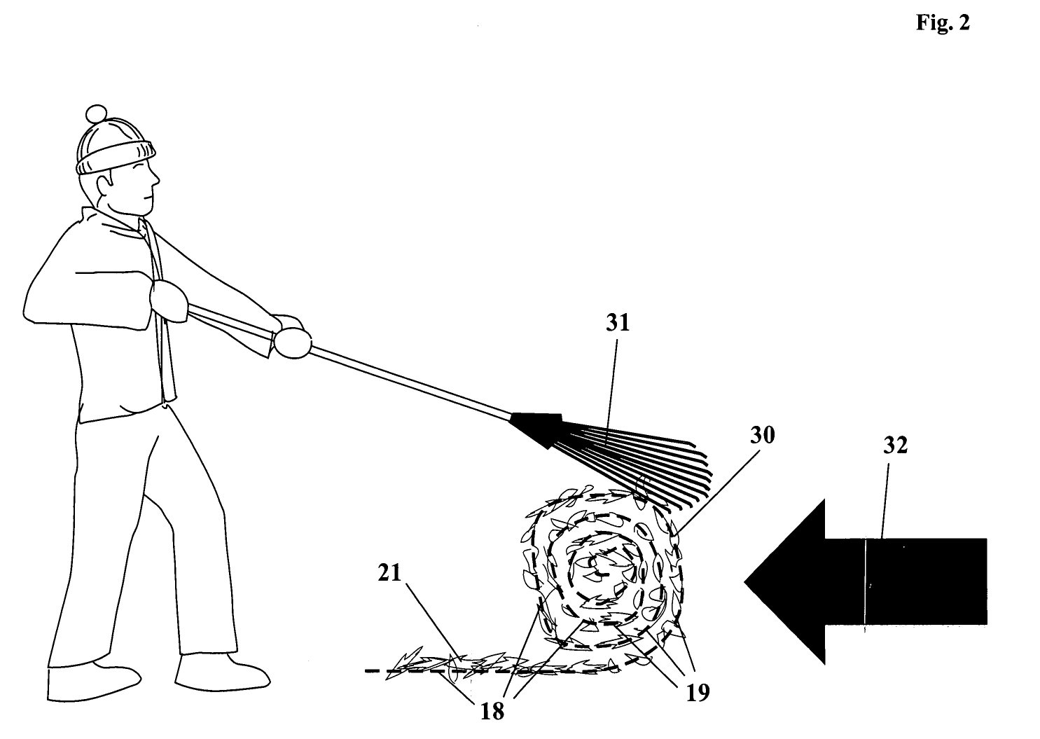

FIG. 2 illustrates an individual rolling the blanket by use of a household rake 31. The individual is drawing the rake 31 toward himself and in the direction of arrow 32.

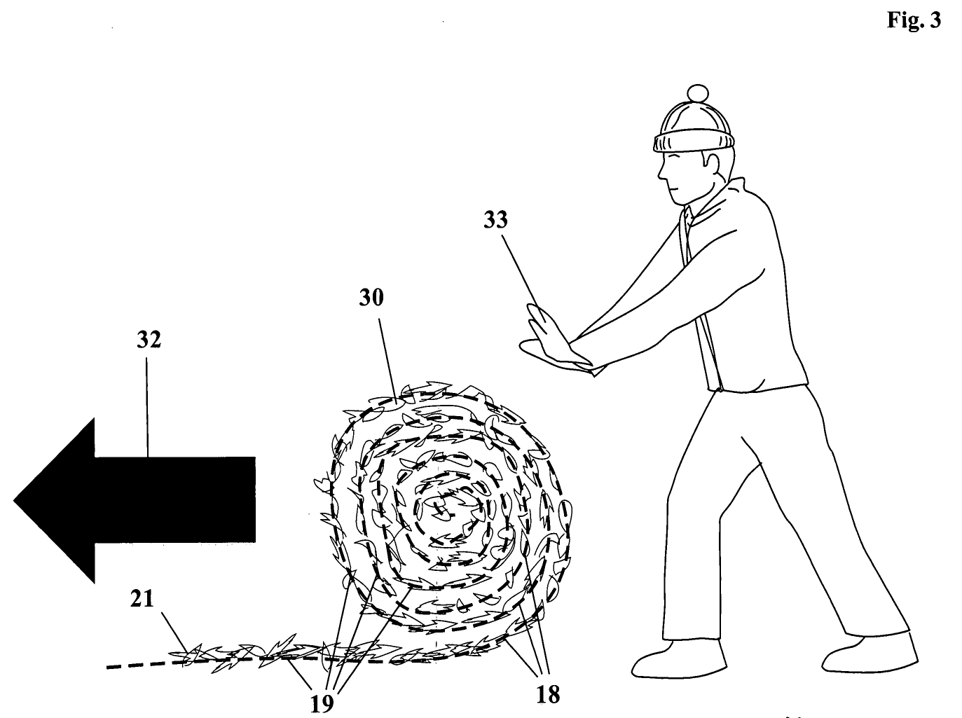

FIG. 3 is a view similar to FIG. 2. The blanket 19 is, however, being rolled in the direction of arrow 32 by pushing of the blanket by hand 33.

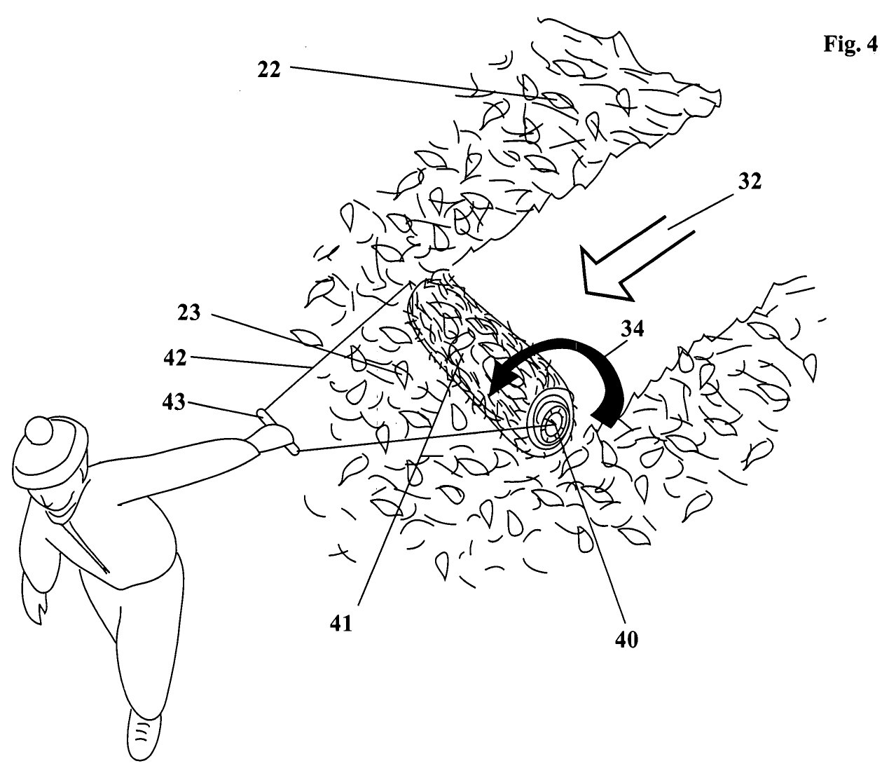

FIG. 4 illustrates a method of collecting leaves where they are more sparsely distributed over a lawn surface. In the case of some trees, no more than two, or maybe three, leaves might occupy, on average, a square foot. Consequently, it may be difficult to form a blanket of overlapping leaves in such a scenario. In such a case, application of an adhesive might be such as in the case of overlapping leaves. Further, however, if necessary, a roller, which could be made of biodegradable cardboard, can be sprayed with the adhesive. The roller is then drawn across the lawn by the individual by means of a handle 43 and a pull cable 42 which runs to both ends of the roller 40. With the adhesive solution still wet, the roller is drawn over the lawn and the randomly distributed leaves 20 adhere to the surface of the roller 40. The roller 40 is drawn in multiple, typically parallel paths along the surface optimally, the practice of such a method allows all leaves to be collected.

FIG. 5 illustrates, in an enlarged view, the application of adhesive 10 to leaves 21. Reference numeral 17 illustrates adhesive having passed through crevices defined between opposing surfaces of the leaves 21 and leached therethrough. It is by this basic application of the adhesive that a blanket is formed.

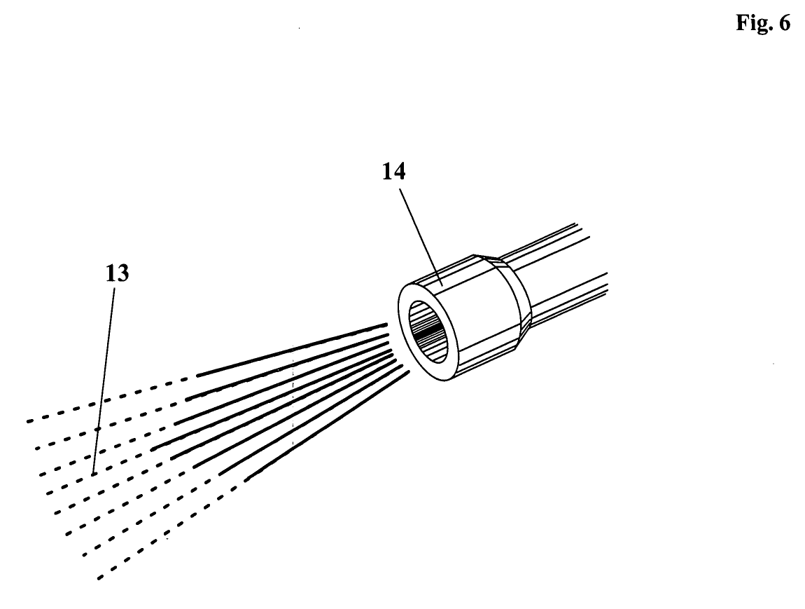

FIG. 6 illustrates a spraying nozzle 14. Adhesive in a liquid form, identified by reference numeral 13, is shown as being ejected from the nozzle 14.

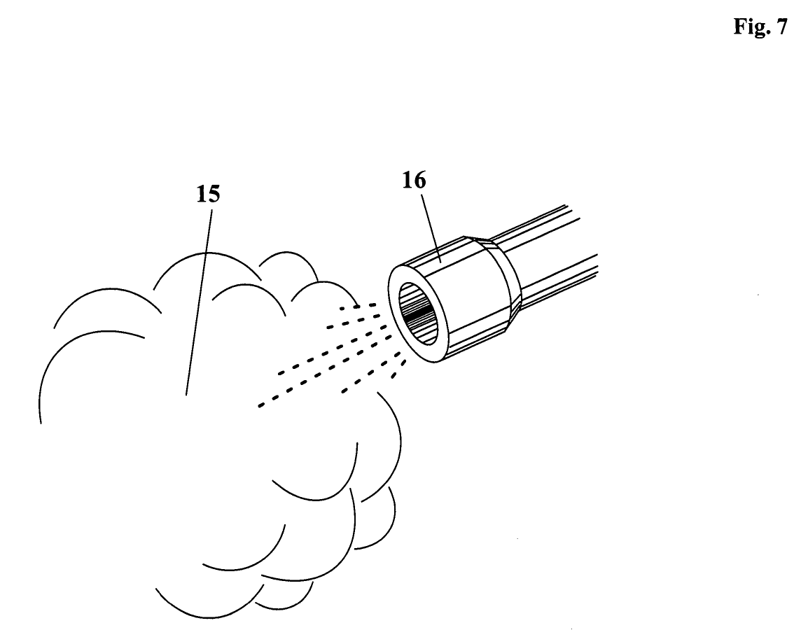

FIG. 7 illustrates a nozzle 16 similar to the nozzle 14 of FIG. 6. Nozzle 16, however, is of a type to generate an atomized mist, identified by reference numeral 15. In some cases, an atomized mist 15 might be more efficient in forming the desired blanket.

In a preferred embodiment of practice, the method, whether intended to use a liquid or atomized adhesive, would preferably employ an adhesive solution which is a synthetic latex. Such an adhesive has properties which facilitate handling and diluting the adhesive to a proper consistency.

It is intended that all components used in the method be biodegradable. Environmental issues are, thereby, made moot.

In a final embodiment of the method, the adhesive could be in a dry, granular form and be broadcast over an area. A reagent—typically liquid in form—could then be applied. Application of the reagent, which could be water, would render the granular adhesive into a liquid form to function for its intended purpose. In this embodiment, once the liquid solution is formed, formation of a blanket proceeds as discussed hereinbefore. The blanket is then allowed to dry and be removed in a manner as previously discussed.

It will be understood that this disclosure, in many respects, is only illustrative. Changes may be made in details, particularly in matters of shape, size, material, and arrangement of parts without exceeding the scope of the invention. Accordingly, the scope of the invention is as defined in the language of the appended claims.

What is claimed is:

1. A method of removing a multiplicity of overlapping, sheet-like articles from an area surface, comprising the steps of:
providing an adhesive solution having a level of tackiness sufficiently high wherein, when the solution is applied over the area, the articles will adhere to one another, but a blanket formed thereby is easily withdrawn from the surface;
applying the solution over the area;
allowing the solution to dry; and
withdrawing the blanket from the surface.

2. A method in accordance with claim 1 wherein said adhesive solution forms a flexible film upon drying.

3. A method in accordance with claim 2 wherein said adhesive solution is a synthetic latex.

4. A method in accordance with claim 1 wherein said adhesive solution is diluted so as to enable application by a conventional spraying instrument.

5. A method in accordance with claim 1 wherein said adhesive solution is applied over the area by spraying.

6. A method in accordance with claim 1 wherein said adhesive solution is biodegradable.

7. A method in accordance with claim 1 wherein, prior to drying, the adhesive solution leaches through overlapping articles.

8. A method for removing a multiplicity of leaves from a ground surface, wherein said leaves generally overlap other of said leaves, comprising the steps of:
providing an adhesive solution having a degree of tackiness sufficiently high so that, when the solution is applied over the ground surface, the leaves adhere to one another, but a blanket formed by adhesion of the leaves one to another is easily withdrawn from the surface;
applying the solution over the ground surface;
allowing the solution to dry; and
withdrawing the blanket from the surface.

9. A method in accordance with claim 8 wherein the step of withdrawing the blanket from the ground surface includes rolling the blanket to define a compact package.

10. A method in accordance with claim 8 wherein the step of applying the solution over the ground surface includes application of the solution in a liquid state.

11. A method in accordance with claim 8 wherein the step of applying the solution over the ground surface includes application of the solution in an atomized state.

12. A method of removing a multiplicity of generally overlapping leaves from a ground surface, comprising the steps of:
broadcasting a granular adhesive over the ground surface;
applying a reagent over the granular adhesive material to provide an adhesive solution having a level of tackiness sufficiently high wherein the leaves will adhere to one another, but a blanket formed by the leaves is easily withdrawn from the surface; and
allowing the adhesive to dry.
